(19) United States
(12) Patent Application Publication
(10) Pub. No.: US 2005/0170688 A1
(43) Pub. Date: Aug. 4, 2005

(54) In-line socket device and its fabricating method

(76) Inventor: W. T. Chen, Hsinchu (TW)

Correspondence Address: MCGLEW & TUTTLE, PC, P.O. BOX 9227, SCARBOROUGH STATION, SCARBOROUGH, NY, 10510-9227, US

(21) Appl. No.: 10/771,106

(22) Filed: Feb. 3, 2004

(51) Int. Cl. H01R 11/00

(52) U.S. Cl. 439/502

(57) ABSTRACT

Disclosed is an in-line socket device and its fabricating method. The in-line socket device is covered with a cover shell, and has a movable safety cover connected with one end of the cover shell. The socket device is composed of a base and a base cover, in which one end of the base is open and the other end has three plug sockets. A plurality of axial slots are formed inside the opened end for covering up wires, and terminals are provided within axial slots to make the crimping end and the bared wire to be clipped; accordingly, partial sections of the wires connected with the terminal crimping end can crimp the bared wire through peeling off the PVC cover layer of the section, so that the integrity of wires can be ensured and the problem of power consumption or fallen off from the connection can be prevented.

### BACKGROUND OF THE INVENTION

1. Field of the Invention

The present invention relates to an in-line socket device and its fabricating method, and more particularly to an in-line socket device and its fabricating method, which can maintain the integrity of the internal wire in the socket without the problem of connection and falling off, and have a safety cover to prevent from the danger of mis-plug-in and getting an electric shock.

2. Description of the Prior Art

Accordingly, the use of sockets is essential to home use or the place of using electric appliances. As shown in the figures, a positive conductor terminal 11, a negative conductor terminal 12, and a grounding conductor terminal 13 are set up in the internal partition of the socket 1, and the central section of each conductor terminal forms axial extension portion to plug in the plug socket of the socket. The two end of the socket are connected to the wires 141, 142, 143, 151, 152, and 153 of the first wire 14 and second wire 15, wherein after the current flows through the first wire 14 to the second wire 15, a positive conductor terminal 11 and negative conductor terminal 12 in the socket can be simultaneously conducted by electric current, so that a plug is plugged to conduct electricity.

The structure of the socket described above has deficiencies as stated below:
1. The internal part of the plug mainly uses the copper material of the terminal as the medium of the first wire and the second wire. Since the material cost of copper terminal is high, the cost of the socket is increased.
2. The power transmission of the first wire and the second wire needs to be completed by the terminal, which relatively results in incompletion and incoherency of power transmission. No matter the terminals are connected to the wires through entwined or welding, it is more likely to cause power wastage due to the difference of the connecting part or the terminal material and wire quality.
3. As the first wire and the second wire are connected to the terminals point to point, this also makes the wires easily felt off as a result of the impact of external force, which causes breaking circuits and electric shock, and even increases the possible instability and danger for personnel and productivity of a factory when used in a high-voltage power supply place.
4. Under the general condition, the socket appears to be totally bared. Consequently, it is possible for a child to mis-plug a small piece of metal into the socket and brings about the danger of electric shock.

Accordingly, the present invention has been invented for many years to solve the above-mentioned problems occurred in the prior art.

### SUMMARY OF THE INVENTION

Accordingly, an object of the present invention is to provide an in-line socket device, which completely changes the conventional way of cutting off the power in order for connection, that is, directly peeling off the outer wire layer of the wire so that the wire can provide power transmission without lose of integrity. This not only solves the problem of unstable power transmission, but also avoids the time and cost of welding or reprocessing after entwined.

According to the in socket of the present invention, the current is transmitted through the wire, therefore, the terminal materials can be largely reduced, and the material cost can be relatively reduced, so that the purpose of facilitating the assembly can be achieved.

According to the in-line socket of the present invention, a cover shell is set in the external part of the socket, which covers the combined socket device. One end of the cover shell is transparent part, which exposes the plug socket of the socket for plug in. Besides, a safety cover is provided, which is connected to the cover shell through one end and its size is approximately equal to the transparent part of the cover shell, so that the plug socket of the socket can be completely covered to ensure safe use.

According to the in-line socket of the present invention, the base of the socket can be made from transparent materials. Then, neon lamps can be used in the socket to timely show the status of electric conduction for the users' convenience.

The present invention further provides a method of fabricating the in-line socket device, wherein the wires are connected to the socket. The socket, comprising a base and a base cover, is formed through injection molding. One end of the molded base is opened and the other end has three plug sockets, wherein three through axial slots, adaptive spaces that can adopt conductor terminals, and scarf holes are formed. The positive terminal, negative terminal, and ground terminal are formed through punching, and the crimping end of the terminals are upward raised arc conductor slices, then, its body is extended downward to form a terminal clip-head or clip tube, next, covering the wires that have been peeled off the outer layer PVC and internal layer PVC to the axial slot of the base, connecting the bared wires to the positive terminal, negative terminal, and ground terminal, and then combine the base cover; After that, forming the cover shell through injection molding in the external part of the socket, and the safety cover connected to one end of the cover shell, and forming a tenon in the combination end of a safety cover in order to promptly cover the plug socket of the socket for safe covering.

The detailed structure, application rationale, features and advantages of the present invention will be more apparent from the following detailed description taken in conjunction with the accompanying drawings:

### BRIEF DESCRIPTION OF THE DRAWINGS

FIG. 1 is a three-dimensional view of the conventional socket.

FIG. 2 is a three-dimensional disassembled view of the present invention.

FIG. 3A is a partial three-dimensional disassembled view of the present invention.

FIG. 3B is a top view of a base according to the present invention.

FIG. 3C is a bottom view of a base according to the present invention.

FIG. 3D is a cross-sectional view of a base according to the present invention.

FIG. 4 is a partial three-dimensional disassembled view of the present invention.

FIG. 5A is a three-dimensional view of the combination of a socket device according to the present invention.

FIG. 5B is a front view of the combination of a socket device according to the present invention.

FIG. 6A is a top view of a cover shell according to the present invention.

FIG. 6B is a cross-sectional view of a cover shell according to the present invention.

FIG. 6C is a bottom view of a cover shell according to the present invention.

FIG. 7 is a graph showing a cover shell and safety cover according to the present invention.

FIG. 8 is a three-dimensional view of the second embodiment according to the present invention.

FIG. 9 is a three-dimensional disassembled view of the second embodiment according to the present invention.

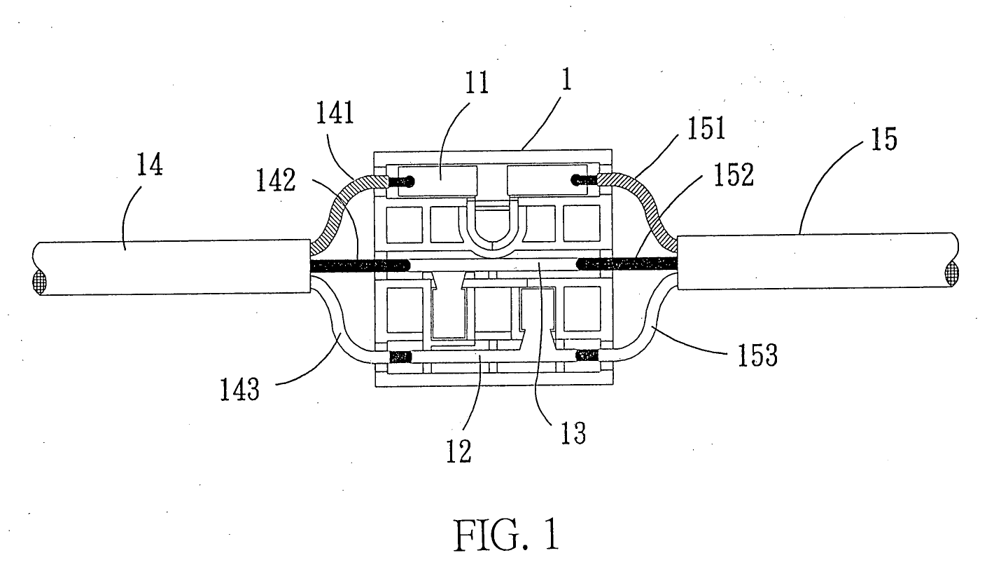

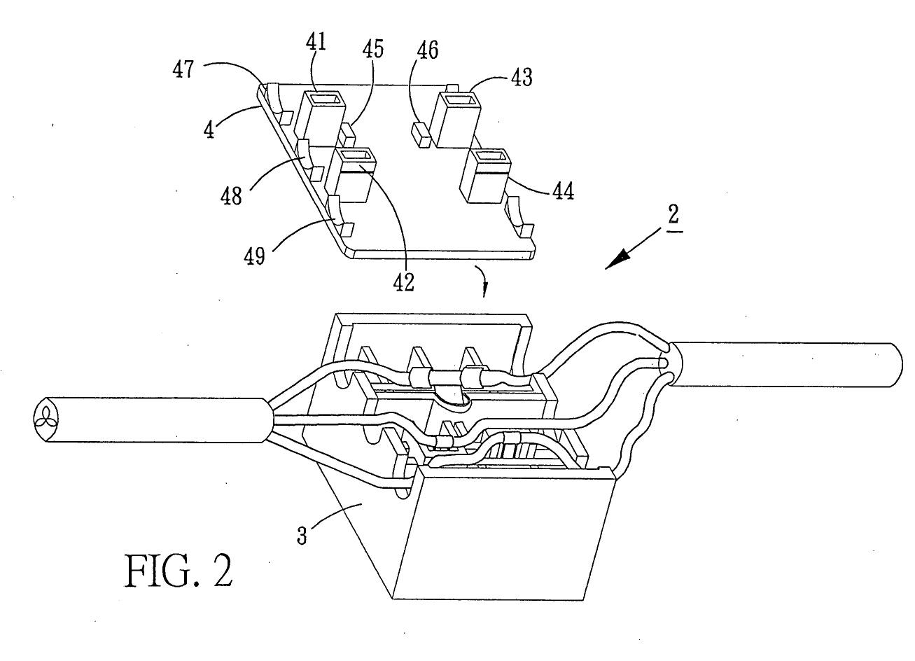

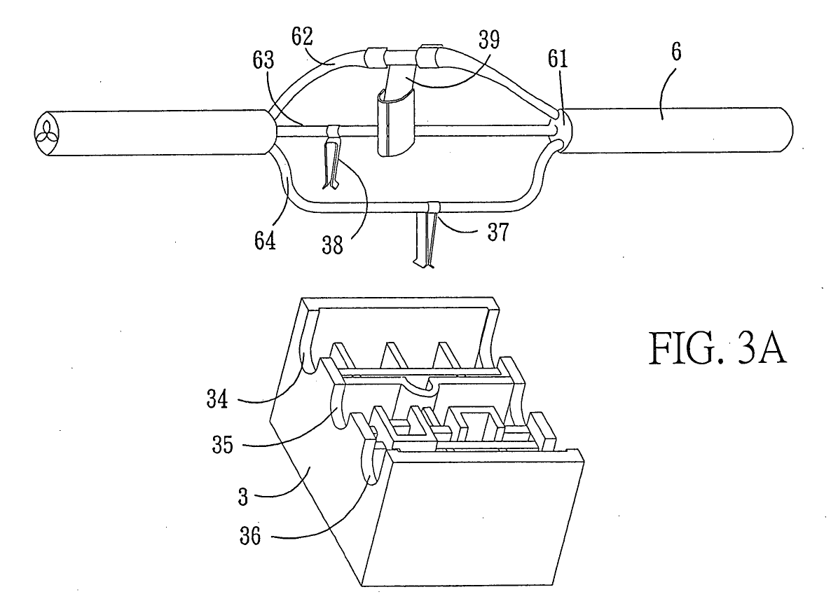

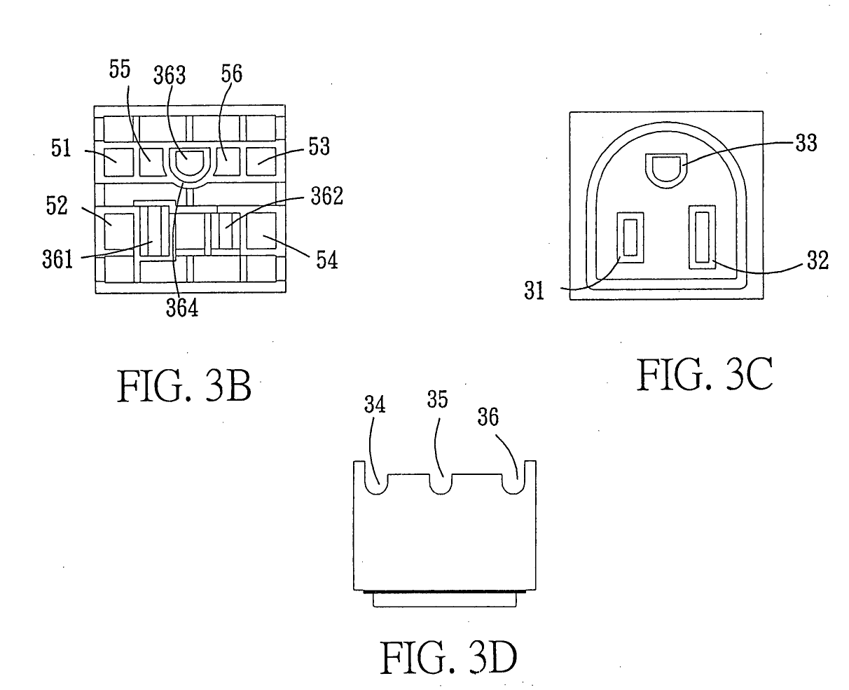

### DETAILED DESCRIPTION OF THE PREFERRED EMBODIMENTS

The structures, advantages, and disadvantages concerning three examples of conventional power pack modules have been already described above; therefore, it is not necessary to discuss again.

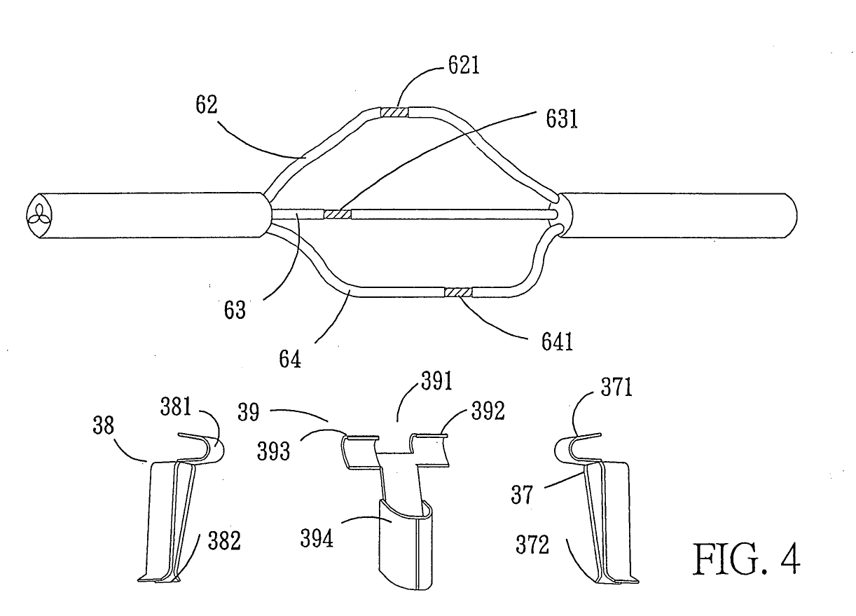

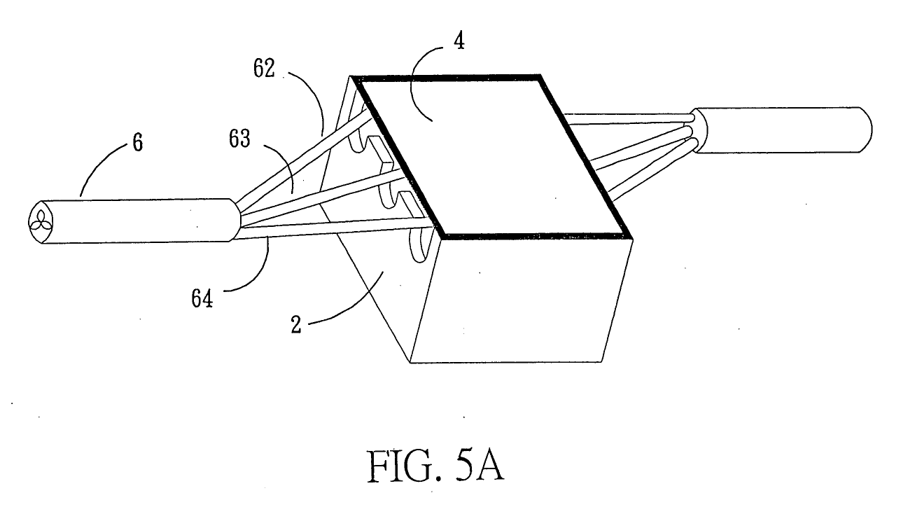

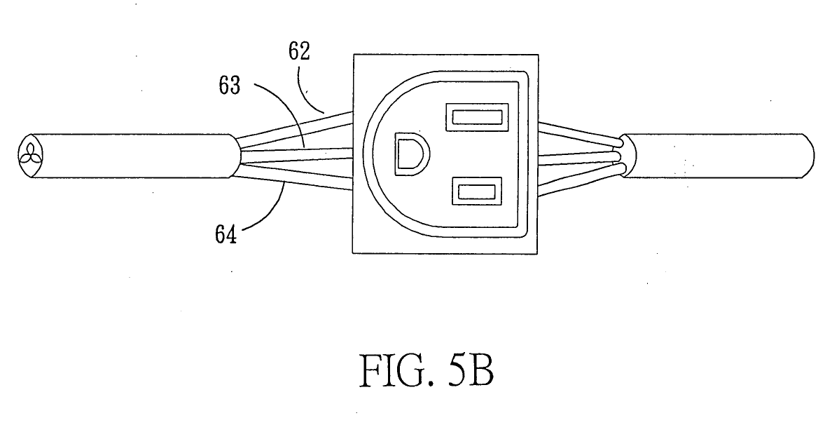

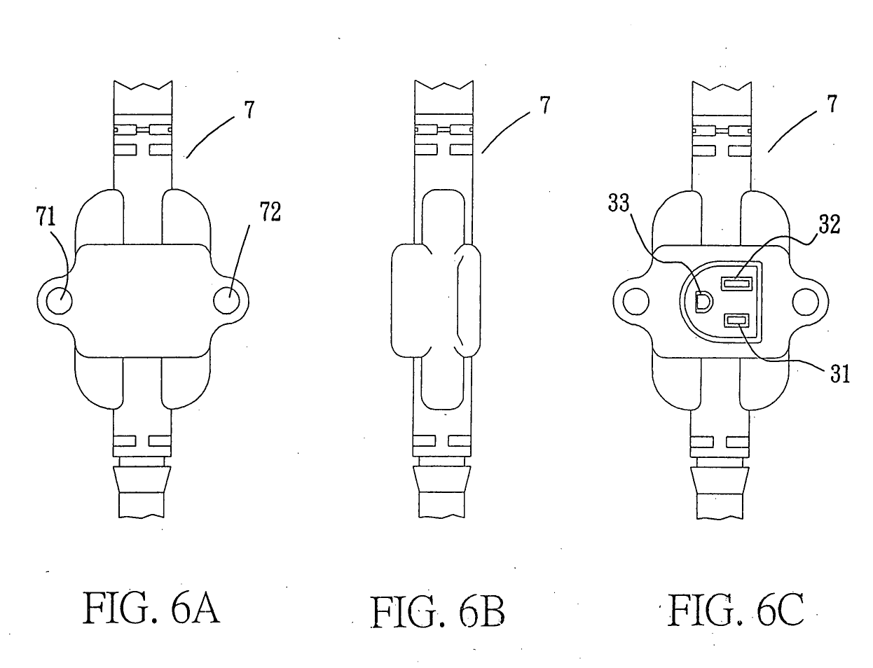

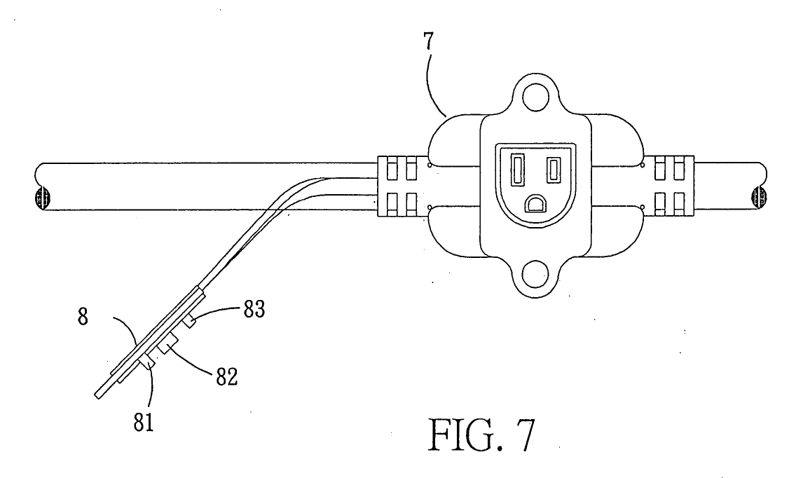

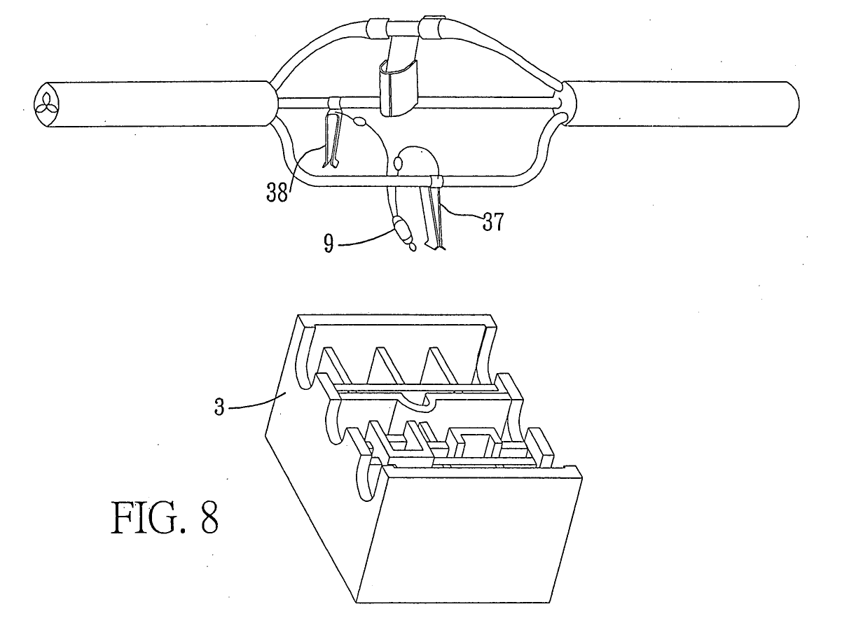

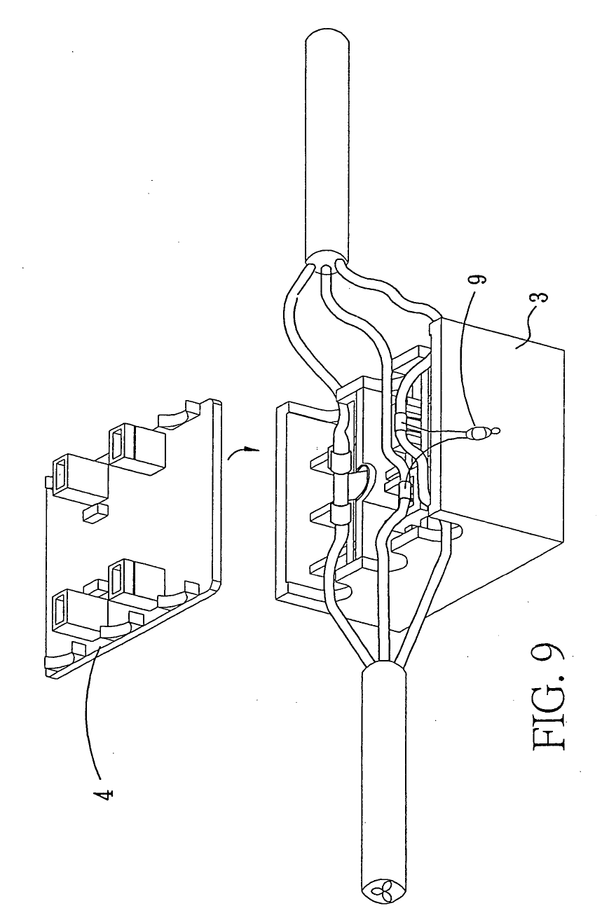

Referring to FIG. 4A and FIG. 4B, the power module package of the present invention is composed of a metal plate 11, a printed circuit board (PCB) 12, a substrate 13, a plurality of chips 14, 15 . . . , a lead frame 16, and a package material 17. The metal plate used as a substrate or a heat dissipation plate as well can be made of copper or aluminum. The PCB12 concentrates circuit patterns of the power pack module on it. The substrate 13 is preferably a high heat dissipation plate made of a high molecular insulation layer or a ceramic insulation layer and attached with a metal foil layer on each surface. The chips 14, 15 . . . are essentially fixed on the substrate 13, or partially fixed on a portion of the PCB 12. The lead frame 16 is in contact with the PCB 12. In fabricating the power module described above, at first the circuit of the power module is formed on the PCB 12; and then the chips 14, 15 . . . are fixed on the substrate 13 at a preset position; afterwards, the PCB 12 and substrate 13 are adhered on the metal plate 11, then put into the lead frame 16 so as to be connected to the circuit formed on the PCB 12, and by pressure welded the chips 14, 15, the PCB12, and the wire 18 connected via the PCB 12 and the substrate 13, and then the structure is put into a case and infused with a packaging material 17 such that the present invention is obtained.

As it will be understood from the above description, the structure of the power module package according to the present invention is characterized in that the substrate 13 is a very thin high heat dissipation layer made of a high molecular insulation layer or a ceramic insulation layer attached with a metal foil layer on each surface. As a result, the cost of substrate material used is greatly reduced compared with that of any conventional one. Moreover, the design of overall circuits formed on the PCB12 contributes to improving the density and precision of the power pack module structure. Besides, the button surfaces of PCB and the substrate for chips 14 to attach are welded with the metal plate 11. By doing so, an excellent thermal conductivity is obtained which makes the structure being able to withstand a high temperature generated from a large instantaneous current and to have a sufficient creepage distance thereby greatly improving safety of the product.

From the above description, it is clearly understandable that the high density power module package of the present invention comprises the functions of increasing the circuit density and accuracy, excellent heat dissipation, low manufacturing cost and more secure in operation. These functions would improve the shortcomings happened in conventional power modules. It is an invention which is worthy for industrial utilizations.

Those who are skilled in the art will readily perceive how to modify the invention. Therefore the appended claims are to be construed to cover all equivalent structures which fall within the true scope and spirit of the invention.

1. An in-line socket device,
comprising:
a base with a opened side and a closed bottom side, a plurality of plug sockets passed through the closed bottom side, and a plurality of adaptive spaces;
a cover base connected to the opened side of the said base to form a closed socket;
a plurality of internal wires, which are passed and provided in the connecting point of the said base and base cover; at least one section in the internal wire is the bared wire that has been peeled off from an insulating layer;
a plurality of terminals, which are corresponded to the position of the said base plug socket and adapted in the adaptive space of the base, and its one end is connected to the said bared wire; and
a cover shell, which covers the said base, base cover, and their peripheral power adapter.

2. The in-line socket device as claimed in claim 1, wherein the wires are continuous.

3. The in-line socket device as claimed in claim 1, wherein the connecting surface of the base cover and the opened side of the base forms a plurality of axial slots to allow internal wires to be fixed.

4. The in-line socket device as claimed in claim 3, wherein the axial slot of the base is dis-continued.

5. The in-line socket device as claimed in claim 3, wherein the axial slot of the base is a partial arc slot.

6. The in-line socket device as claimed in claim 1, wherein a partial arc raised pillar is formed in the bottom side of the base cover that corresponds to the axial slot of the base, which can completely packet and clip the passed wire after combined with the base.

7. The in-line socket device as claimed in claim 3, wherein a partial arc raised pillar is formed in the bottom side of the base cover that corresponds to the axial slot of the base, which can completely packet and clip the passed wire after combined with the base.

8. The in-line socket device as claimed in claim 1, wherein one end of the terminal is bended upward to connect to the bared wire.

9. The in-line socket device as claimed in claim 1, wherein the said terminal is clipped by the clip head for clipping the plug conducting pillar.

10. The in-line socket device as claimed in claim 7, wherein the said terminal is clipped by the clip head for clipping the plug conducting pillar.

11. The in-line socket device as claimed in claim 1, wherein the said terminal is a clip tube with arched edge for clipping the plug grounding pillar.

12. The in-line socket device as claimed in claim 7, wherein the said terminal is a clip tube with arched edge for clipping the plug grounding pillar.

13. The in-line socket device as claimed in claim 1, wherein the said terminals include the positive terminal, negative terminal, and grounding terminal.

14. The in-line socket device as claimed in claim 7, wherein the said terminals include the positive terminal, negative terminal, and grounding terminal.

15. The in-line socket device as claimed in claim 1, wherein the one end of the said cover shell is transparent, making the plug socket of the socket exposed.

16. The in-line socket device as claimed in claim 1, wherein the one end of thee said cover shell is connected to a safety cover, which covers the plug socket so that the unusual matter in the plug socket can be prevented.

17. The in-line socket device as claimed in claim 10, wherein the one end of the said cover shell is connected to a safety cover, which covers the plug socket so that the unusual matter in the plug socket can be prevented.

18. The in-line socket device as claimed in claim 11, wherein one end of the said safety cover that is relative to a plug socket forms a plurality of raised pillars to allow the plug socket plugged into the socket to be fixed.

19. The in-line socket device as claimed in claim 1, wherein the internal part of the said bass has neon lamps to indicate the status of power supply.

20. The in-line socket device as claimed in claim 1, wherein the said base can be made from transparent materials.

21. The in-line socket device as claimed in claim 13, wherein the said base can be made from transparent materials.

22. An in-line socket device, comprising:
a base with a opened end and a closed bottom side, a plurality of plug sockets passed through the closed bottom side, and a plurality of adaptive spaces;
a base cover, which is connected to the opened end of the said base to form a closed socket;
a plurality of internal wires, which are passed and provided in the connecting point of the said base and base cover; at least one section in the internal wire is the bared wire that has been peeled off from an insulating layer; and
a plurality of terminals, which are corresponded to the position of the said base plug socket and adopted in the adaptive space of the base, and its one end is connected to the said bared wire.

23. The in-line socket device as claimed in claim 16, wherein the said wire is continuous.

24. The in-line socket device as claimed in claim 16, wherein the opened end of the said base is connected to the base cover to form a plurality of axial slots, so that the internal power adapter can be fixed.

25. The in-line socket device as claimed in claim 18, wherein the axial slot of the said base is dis-continued.

26. The in-line socket device as claimed in claim 18, wherein the said axial slot of the base is a partial arc slot.

27. The in-line socket device as claimed in claim 16, wherein a partial arc raised pillar is formed in the bottom side of the base cover that corresponds to the axial slot of the base, which can completely packet and clip the passed wire after combined with the base.

28. The in-line socket device as claimed in claim 16, wherein one end of the said terminal is extended and bended upward to be connected to the bared wire.

29. The in-line socket device as claimed in claim 16, wherein the said terminal is a terminal clip head for clipping the plug conducting pillar.

30. The in-line socket device as claimed in claim 22, wherein the said terminal is a terminal clip head for clipping the plug conducting pillar.

31. The in-line socket device as claimed in claim 16, wherein the said terminal is a clip tube with arched edge for clipping the plug grounding pillar.

32. The in-line socket device as claimed in claim 22, wherein the said terminal is a clip tube with arched edge for clipping the plug grounding pillar.

33. The in-line socket device as claimed in claim 16, wherein the said terminals include the positive terminal, negative terminal, and grounding terminal.

34. The in-line socket device as claimed in claim 22, wherein the said terminals include the positive terminal, negative terminal, and grounding terminal.

35. The in-line socket device as claimed in claim 16, wherein the internal part of said base has neon lamps to indicate the status of power supply.

36. The in-line socket device as claimed in claim 16, wherein the said base can be made from transparent materials.

37. A method for fabricating a in-line socket device, the method comprising the steps of:
forming a base and a base cover through injection molding, making one end of the base as opened end and the other as closed, which has a plurality of plug sockets, in which a plurality of through axial slots and adaptive spaces that can adopt conductor terminals are formed;
forming the said conductor terminals through stamping, making the end of the conductor terminals extended toward one end;
covering the wires that have been peeled off the outer layer PVC and internal layer PVC to the axial slot of the base, and connecting the bared wires to the terminals;
assembling a base cover; and
forming a cover shell and a safety cover that is connected with one end of the cover shell in the external part of the socket through injection molding.
